(19) United States
(12) Patent Application Publication
(10) Pub. No.: US 2005/0284181 A1
(43) Pub. Date: Dec. 29, 2005

(54) Method for making an optical waveguide assembly with integral alignment features

(76) Inventors: Terry L. Smith, Roseville, MN (US); Jun-Ying Zhang, St. Paul, MN (US); Rutesh D. Parikh, Austin, TX (US); Jeremy K. Larsen, Oakdale, MN (US)

Correspondence Address: 3M INNOVATIVE PROPERTIES COMPANY, PO BOX 33427, ST. PAUL, MN, 55133-3427, US

(21) Appl. No.: 10/879,716

(22) Filed: Jun. 29, 2004

(51) Int. Cl. C03B 37/022

(52) U.S. Cl. 65/386

(57) ABSTRACT

An optical waveguide assembly has integral alignment features. The waveguide assembly is formed by fabricating a waveguide on a substrate prior to forming the alignment features, removing a portion of the waveguide to reveal the substrate, and forming the alignment feature in the substrate.

### BACKGROUND OF THE INVENTION

The present invention generally relates to a method for making an optical waveguide assembly.

Optical waveguide chips are utilized in a wide variety of optical communication systems, such as telecommunications networks. The optical waveguide chips are substantially planar optical circuits consisting of one or more optical waveguides fabricated on a silicon or silicon dioxide chip or wafer. In one common construction, the waveguide cores are sandwiched between protective lower and upper cladding layers.

For use, the waveguides of the waveguide chip are connected to external circuits or other devices by coupling the ends of the waveguides to optical fibers. The accuracy and precision of the fiber and waveguide alignment greatly affects the optical coupling loss experienced at the interface of the fiber and waveguide.

Optical waveguides with integral optical fiber alignment features are known. In known waveguides with integral alignment features, the alignment features are either formed at the beginning of the manufacturing process (as exemplified by U.S. Pat. No. 4,474,425, S. J. Park et al.) or at the same time that the waveguide core pattern is formed (as exemplified by U.S. Pat. No. 5,600,745). In both cases, one or more layers of the waveguide structure are subsequently deposited on the alignment features after the original formation of the alignment features. The subsequently deposited layers must be removed in a later process step in order to open the alignment features for use. Removal of the subsequently deposited layers often results in a loss of the precision of the originally formed alignment features. In addition to the loss of precision in the originally formed alignment features, other difficulties are present. For example, in the case where the alignment features are formed at the beginning of the manufacturing process, the alignment features create a non-planar surface which adversely affects the uniformity of subsequent process steps, and the waveguide core pattern process. In the case where the alignment features are formed at the same time that the waveguide core pattern is formed, the formation of the alignment features can contaminate or otherwise adversely affect the surface of core. A need exists for a method for making an optical waveguide with integral alignment features that maintains the accuracy of the passive alignment features without adding complexity or additional steps to the manufacturing process.

### SUMMARY OF THE INVENTION

The invention described herein provides an optical waveguide assembly with integral alignment features, and a method for forming the waveguide assembly. In one embodiment according to the invention, the method for forming the waveguide comprises fabricating a waveguide on a substrate prior to forming an alignment feature, removing a portion of the waveguide to reveal the substrate, and forming the alignment feature in the substrate.

In another embodiment according to the invention, the method comprises depositing an etch stop layer on a substrate, patterning the etch stop layer with an alignment feature pattern, providing a waveguide over the patterned etch stop layer, removing a portion of the waveguide to reveal the patterned etch stop layer, and finally etching the substrate to form alignment features in the substrate.

In yet another embodiment according to the invention, the method comprises providing a waveguide on a substrate, patterning the waveguide with an alignment feature pattern, removing a portion of the waveguide from the substrate to provide an alignment feature mask, and finally etching the substrate using the alignment feature mask to form alignment features in the substrate.

In one embodiment, the waveguide with integral alignment features comprises a substrate having a waveguide thereon, and a patterned etch stop layer positioned between the substrate and the waveguide.

### BRIEF DESCRIPTION OF THE DRAWINGS

FIG. 1 illustrates an embodiment of an optical waveguide assembly having integral alignment features according to the invention.

FIG. 2 illustrates a substrate having an etch stop layer with an alignment feature pattern.

FIGS. 3a and 3b are cross-sectional illustrations of the formation of discrete waveguides on the substrate and etch stop layer of FIG. 2.

FIG. 4 illustrates the optical waveguide assembly of FIG. 1, prior to the formation of the integral alignment features.

FIG. 5 illustrates another embodiment of an optical waveguide assembly having integral alignment features according to the invention.

FIG. 6 is a cross-sectional illustration of discrete waveguides in the optical waveguide assembly of FIG. 5.

FIG. 7 illustrates the optical waveguide assembly of FIG. 5, prior to the formation of the integral alignment features.

### DESCRIPTION OF THE PREFERRED EMBODIMENTS

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is not limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

For purposes of clarity and ease of understanding, the dimensions of some elements in the Figures are greatly exaggerated. Also, the Figures of the present application illustrate a single chip having an optical waveguide assembly according to the present invention. However, the processes described herein are typically carried out at the wafer level, with the processed wafer encompassing a plurality of similar optical waveguide assemblies which are subsequently diced into individual chips, as illustrated in the Figures and described below.

The methods described herein for forming an optical waveguide assembly with integral alignment features do not fabricate the alignment features until after the waveguides are fully formed, thereby increasing the precision of the alignment features and simplifying the waveguide chip fabrication process. The alignment features may be used to align a variety of optical devices, such as optical fibers, ball lenses, grin lenses, or microsphere resonators, to name a few. Exemplary embodiments are provided to illustrate the methods and resulting articles.

### First Exemplary Embodiment

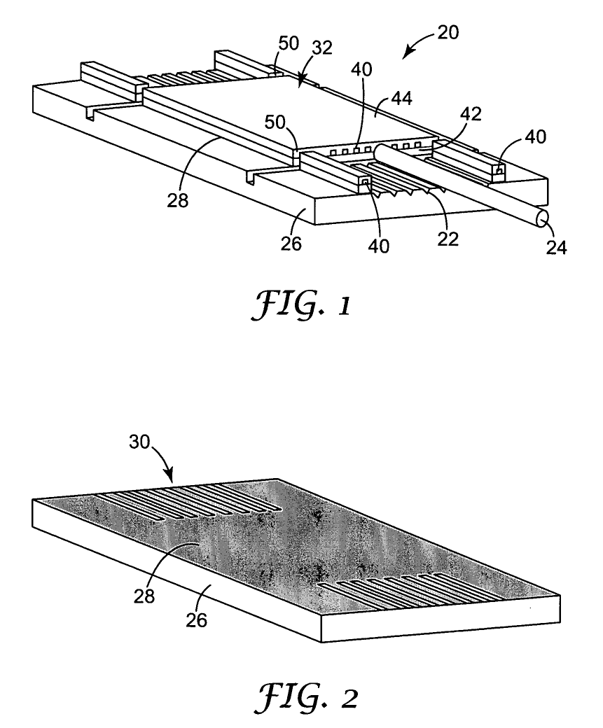

One embodiment of a planar waveguide assembly 20 having integral alignment features 22 for positioning an optical fiber 24 according to the invention is illustrated in FIGS. 1-4. In the exemplary embodiment of FIGS. 1-4, the planar waveguide assembly 20 with integral alignment features 22 is made by coating a substrate 26 with an etch stop layer 28. An alignment feature pattern 30 is formed in the etch stop layer 28 for each waveguide assembly 20 on the substrate 26. The alignment feature pattern 30 is fabricated using photolithography and an etch process. After the alignment feature pattern 30 is fabricated in the etch stop layer 28, the waveguides 32 are grown on top of the substrate 26 and etch stop layer 28 with alignment feature pattern 30. The waveguides 32 are next etched in areas where the alignment feature pattern 30 was previously fabricated to expose the pattern 30. Another etch is performed to create the precision alignment features 22 using the previously fabricated alignment feature pattern 30. The alignment features 22 are illustrated as V-grooves, but may have other cross-sectional profiles as well, including U-shaped, trapezoidal or rectangular grooves. Details of the method used to form the first exemplary embodiment are described in greater detail below.

Alignment Feature Patterning

Substrate 26, for example a silicon wafer (doped or undoped), is cleaned using conventional cleaning processes, and coated on one or both sides with an etch stop layer 28 using known deposition techniques. Etch stop layer 28 is formed from a material selected based upon its ability to endure required process temperatures and to withstand the final etching process used to form the alignment features as described below. For example, where the final etching process is a KOH etch, suitable materials for etch stop layer 28 include silicon nitride, gold, chrome-gold, nichrome, hafnium, hafnium oxide, holmium, holmium oxide, magnesium fluoride, magnesium oxide, tantalum oxide, vanadium, tungsten, zirconium, zirconium oxide. The etch stop layer 28 is deposited on substrate 26 by known processes. For example, suitable techniques include, but are not limited to, thermal evaporation, low pressure chemical vapor deposition (LPCVD) and plasma-enhanced chemical vapor deposition (PECVD).

In the exemplary embodiment, the material used to form etch stop layer 28 is silicon nitride (Si₃N₄), applied with a thickness in the range of 300-6000 Å using a low pressure chemical vapor deposition (LPCVD) process according to the following conditions:
NH₃: 100-500 sccm,
dichlorosilane (DCS): 50-500 sccm,
pressure: 200-400 mTorr,
N₂: 500-300 sccm,
temperature: 700-1130° C.

A coating adhesion promoter such as hexamethyldisilazane is deposited on top of the etch stop layer 28, and a positive photoresist (e.g., Shipley PR1813) is next coated over the adhesion promoter. The adhesion promoter and photoresist may be applied, for example, by spin coating or other suitable known techniques. The construction is then baked at approximately 96° C. for approximately 30 minutes. The photoresist is next exposed using an alignment feature pattern mask aligned to the wafer, and then developed using conventional techniques. The etch stop layer 28 is etched to form the alignment feature pattern 30. Any suitable known etching technique may be used. In the exemplary embodiment, a dry etch technique is used. For example, a reactive ion etch (RIE) process, and specifically an inductive coupled plasma (ICP) process, may be conducted according to the following conditions:
C₄F₈: 10-50 sccm,
O₂: 0.5-5 sccm,
RF power: 50-100 W,
ICP power: 1000-1800 W,
Pressure: 4-10 mTorr.
   After etching, the photoresist is stripped, leaving the etch stop layer 28 with the alignment feature pattern 30 on substrate 26, as shown in FIG. 2. As noted above, for proposes of clarity FIG. 2 shows only a single chip having an alignment feature pattern 30. In practice, a plurality of waveguide chips are formed from a single wafer, and during the alignment feature patterning process a plurality of alignment feature patterns 30 are formed on the wafer. The wafers are next prepared for fabrication of the optical waveguides 32.

Waveguide Fabrication

Prior to fabrication of the waveguides, the wafers and alignment feature pattern are preferably cleaned, such as with a pre-plasma clean. The waveguides are then fabricated using conventional techniques. In the first exemplary embodiment illustrated in FIGS. 1-4, the waveguides 32 comprise a high refractive index core 40 sandwiched between a low refractive index lower cladding layer 42 and a low refractive index upper cladding layer 44. The construction of waveguides 32 used herein is exemplary only; the invention described and claimed herein is equally useful with any waveguide construction. In alternate embodiments, waveguides 32 have other known constructions and are fabricated using other known processes. By way of example, waveguides 32 may be fabricated using ion-exchange processes, or may be of a stripline pedestal anti-resonant reflecting optical waveguide construction.

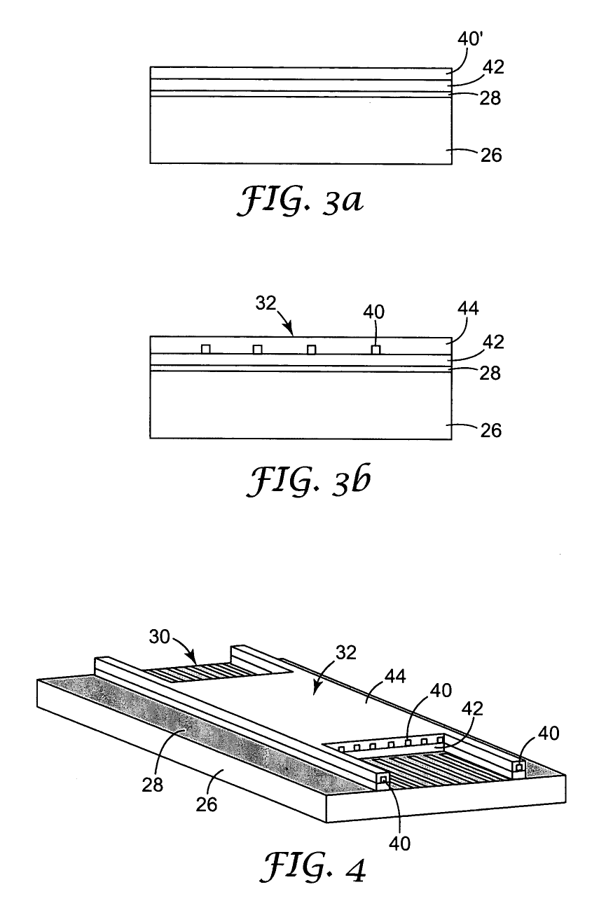

In the first exemplary embodiment, as illustrated in FIG. 3a, a low refractive index lower cladding layer 42 (undoped SiO₂ in the exemplary embodiment) having a thickness in the range of 10-50 μm is deposited over the patterned etch stop layer 28 using a plasma-enhanced chemical vapor deposition (PECVD) technique according to the following conditions:
SiH₄: 10-30 sccm,
N₂O: 500-2000 sccm,
N₂: 100-1000 sccm,
RF power: 50-200 sccm,
Pressure: 1000-2000 mTorr,
Temperature: 300-400° C.
   After deposition, the lower cladding layer 42 is annealed at 700° C.-1400° C. for 2-8 hours.

In alternate embodiments, other low index materials such as magnesium fluoride may be used, as long as the materials are compatible with the subsequent process used to form the alignment grooves. For example, as described below, in one exemplary embodiment the alignment features 22 may be etched into a silicon wafer using an anisotropic etch, such as an anisotropic KOH etch. Some low index materials, such as diamond-like glass (DLG) and many polymers, are not compatible for use with a KOH etch. However, if an alternate to the exemplary KOH etch is used, such materials may be suitable for use.

A high refractive index waveguide core layer 40′ (Ge-doped SiO₂ in the exemplary embodiment) having a thickness in the range of 0.1 μm to 63 μm is next deposited over lower cladding layer 42. The thickness of the waveguide core layer 40′ will vary depending upon the particular application. For example, a multi-mode waveguide will have a core layer 40′ up to approximately 63 μm, while a single-mode waveguide will have a core layer 40′ up to approximately 8 μm. In the exemplary embodiment, the waveguide core layer 40′ can be fabricated using a PECVD technique according to the following conditions:
SiH₄: 10-50 sccm,
GeH₄: 0.5-10 sccm,
N₂O: 500-2000 sccm,
N₂: 100-1000 sccm,
RF power: 50-200 sccm,
Pressure: 1000-2000 mTorr,
Temperature: 300-400° C.
   After deposition, the waveguide core layer 40′ is annealed at 700-1400° C. for 2-8 hours.

In alternate embodiments, other dopants such as phosphorous, titanium, zirconium, tantalum, or hafnium can be used in silica to create a high refractive index core. Alternatively, the core layer 40′ can be fabricated from high index materials such as silicon, titania, zirconia, silicon oxynitride (SiON), or silicon nitride (Si₃N₄).

In other embodiments, the lower cladding layer 42 and waveguide core layer 40′ can be deposited by processes other than the preferred PECVD process described above. For example, other suitable techniques include flame hydrolysis deposition (FHD), chemical vapor deposition (CVD) processes including atmosphere pressure chemical vapor deposition (APCVD) and low-pressure chemical vapor deposition (LPCVD), ion-exchange process, physical vapor deposition (PVD) processes such as sputtering, evaporation, electron beam evaporation, molecular beam epitaxy, and pulsed laser deposition, or sol-gel processes.

After annealing, the waveguide core layer 40′ is coated with aluminum with a thickness in the range of 0.2 to 1 μm by conventional techniques, including sputtering, evaporation, and electron beam evaporation. A positive photoresist is coated on the aluminum layer, and the aluminum layer is patterned using a core pattern mask and standard photolithography techniques. The core pattern mask is aligned to the alignment feature pattern using standard mask alignment techniques. An etch process in then performed to etch the waveguide core layer 40′ and form waveguide cores 40 (FIG. 3b). In the exemplary embodiment, a dry etch is preferred. For example, an RIE etch may be conducted according to the following conditions:
C₄F₈: 10-50 sccm
O₂: 0.5-5 sccm
RF power: 50-100 W
ICP power: 1000-2000 W
Pressure: 3-10 mTorr

After the waveguide cores 40 are formed, upper cladding layer 44 is provided over the waveguide ridges. The upper cladding layer 44 is provided using known suitable low refractive index materials and deposition processes as mentioned with respect to formation of the lower cladding layer 42 and waveguide core layer 40′. In the exemplary embodiment, a borophosphosilicate glass (BPSG) upper cladding layer 44 is grown to a thickness in the range of 5 to 20 μm over the waveguide cores 40, using PECVD according to the following conditions.
SiH₄: 10-50 sccm
B₂H₆: 0.1-10 sccm
PH₃: 0.1-10 sccm
N₂O: 500-2000 sccm
N₂: 100-1000 sccm
RF power: 50-200 sccm
Pressure: 1000-2000 mTorr
Temperature: 300-400° C.
   After the BPSG layer is formed, the assembly is heated and allowed to reflow at 800-1200° C. for 2-10 hours.

Reveal Alignment Feature Pattern

After the waveguides 32 are formed on top of the substrate 26 and previously fabricated alignment feature pattern 30, the upper cladding layer 44 is coated with 1 to 3 μm aluminum using conventional techniques, including sputtering, evaporation, and electron beam evaporation. To reveal the previously fabricated alignment feature pattern 30, a positive photoresist is coated on the aluminum layer and patterned with a mask using standard photolithography techniques. The mask is configured to allow the previously fabricated alignment feature pattern 30 to be revealed by etching the waveguide structure 32, as illustrated in FIG. 4. In the exemplary embodiment, a dry etch is used to remove the portion of the waveguides 32 over the alignment feature pattern 30. For example, an RIE etch may be performed according to the following conditions:
C₄F₈: 10-50 sccm
O₂: 0.5-5 sccm
RF power: 50-100 W
ICP power: 1000-2000 W
Pressure: 3-10 mTorr
   In a preferred embodiment, the RIE etching removes most of the waveguide 32 layers, with any remaining waveguide layer material removed by a wet chemical etchant such as hydrofluoric acid (HF).

The remaining aluminum is stripped by etching. In the exemplary embodiment, a wet etch using H₄PO₃/HNO₃/glacial acetic acid is conducted to remove the aluminum. The assembly is now ready for formation of the alignment features 22 by etching of the substrate 26.

Fabrication of Alignment Features

Referring again to FIG. 1, alignment features 22 are next formed in the substrate 26 by etching, using the previously fabricated alignment feature pattern 30 to define the position and size of the alignment features 22. The alignment features 22 are etched using conventional techniques, and the particular etch technique will depend upon the material used as the substrate 26 and upon the material used to form the etch stop layer 28. In the exemplary embodiment, where the substrate 26 is a silicon wafer and silicon nitride is used to form the etch stop layer 28, the alignment features 22 may be etched into the silicon wafer using an anisotropic etch, such as an anisotropic KOH etch.

A suitable anisotropic etchant is a mixture of KOH and water (10-50 wt % KOH in water, preferably 35%) at temperatures between 25-100° C., preferably at 85° C. The etchant is preferably agitated to improve the uniformity of etching rates over relatively large areas of the substrate 26. The etch time depends on the width of the alignment features 22 defined by the alignment feature pattern 30.

A silicon wafer has different chemical features in different directions due to the lattice structure of the wafer. Namely, in the (100), (110), and (111) directions the wafer has an increasing atomic density. For an orientation-dependent etchant (e.g., 10-50 wt % KOH in water) the etch rate in the (111) direction is much smaller than the etch rate in the (100) and (110) directions, such that etching the silicon wafer in the (100) direction with the orientation-dependent etchant will result in V-shaped alignment features 22. Where the etching is not done to completion, the alignment features 22 will have a trapezoidal shape. The geometrical construction of the alignment features 22 formed by anisotropic etching is directly related to the etching window provided by the alignment feature pattern 30 in the etch stop layer 28.

The remaining exposed portions of etch stop layer 28 may optionally be removed by a suitable etching process. It may be desirable to remove exposed areas of etch stop layer 28 to ensure no “overhang” exists along alignment features 22. If not removed, overhanging portions of etch stop layer 28 may break off and fall into alignment features 22, where the debris may cause misalignment of the optical device placed in the alignment feature. The unexposed portions of etch stop layer 28 will remain under waveguides 32.

Assembly

After etching of the alignment features 22, the substrate is ready for additional processing to form individual waveguide chips having integral alignment features, as illustrated in FIG. 1. Prior to dicing the substrate (a wafer in the exemplary embodiments), a saw cut 50 is made at the junction of the waveguide cores 40 and alignment features 22 to remove any residual radius at the junction and provide a flat surface at the end of the waveguide cores 40 suitable for mating to an optical fiber or other optical device. This flat surface may be perpendicular to the wafer surface, or angled for reduction of optical reflections. Strips of waveguide chips (not shown) are then diced from the substrate 26, and the ends of the waveguide cores 40 may be given an additional optical polishing treatment. The strips of waveguide chips are then further diced to separate individual planar wave-guide assemblies 20. The singulated assemblies are then ready for cleaning and assembly with optical fibers 24.

The singulated waveguide assembly, as shown in FIG. 1, thus comprises a substrate 26 having alignment features 22 formed therein. An etch stop layer 28 covers the substrate 26. The etch stop layer 28 includes a patterned portion 30 corresponding to a pattern of alignment features 22. A waveguide structure 32 is positioned on the etch stop layer 28, with only the patterned portion 30 of the etch stop layer 28 uncovered or revealed by waveguide structure 32. The uncovered or revealed patterned portion 30 of the etch stop layer 28 may optionally be removed after formation of alignment features 22. A portion of the etch stop layer 28 remains positioned between the substrate 26 and the waveguide structure 32, even if pattered portion 30 is removed.

In a preferred embodiment, the waveguide assembly comprises a silicon substrate 26 having a plurality of V-shaped alignment features 22 formed therein. A silicon nitride etch stop layer 28 covers the substrate 26 between substrate 26 and waveguide structure 32. Waveguide structure 32 includes a plurality of waveguide cores 40 (each corresponding to an alignment feature 22) sandwiched between a lower cladding layer 42 and an upper cladding layer 44.

### Second Exemplary Embodiment

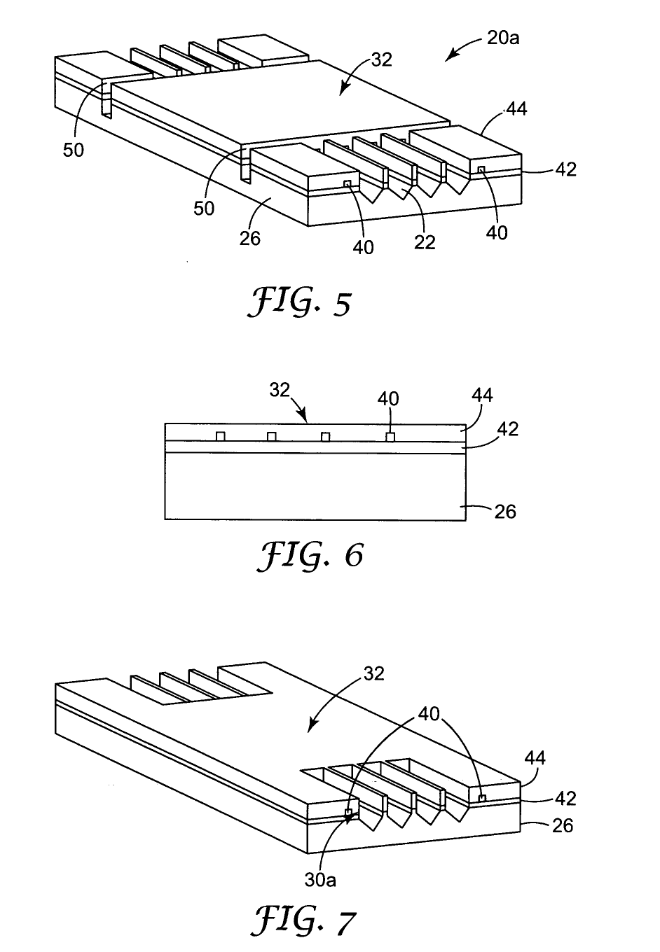

Another embodiment of a planar waveguide assembly 20a, having integral alignment features according to the invention is illustrated in FIGS. 5-7. In the second exemplary embodiment, the integral alignment features 22 are made using the waveguide material structure 32 itself as the pattern for the alignment features 22. As compared to the first exemplary embodiment of FIGS. 1-4, the second exemplary embodiment eliminates the fabrication of alignment feature pattern 30 described above, thereby, reducing process steps. Waveguides 32 are directly deposited on the substrate 26 (a silicon wafer in the exemplary embodiment) and then etched to form a pattern 30a for the alignment features 22 formed in a latter etch step. The alignment features 22 are illustrated as V-grooves, but may have other cross-sectional profiles as well, including U-shaped or rectangular grooves. Details of the method used to form the second exemplary embodiment are described in greater detail below.

Waveguide Fabrication

Prior to fabrication of the waveguides, the substrate 26 is preferably cleaned using conventional techniques, such as a pre-plasma clean. The waveguides 32 are then fabricated using conventional techniques. In the second exemplary embodiment, as shown in FIG. 6, the waveguides 32 comprise a high refractive index core 40 sandwiched between a low refractive index lower cladding layer 42 and a low refractive index upper cladding layer 44. The waveguides 32 may be fabricated using the same processes and conditions as described above with respect to the first exemplary embodiment.

Alignment Feature Patterning

After the waveguides 32 are formed on the substrate 26, the upper cladding layer 44 is coated with 1 to 3 μm of aluminum using conventional techniques, including sputtering, evaporation, and electron beam evaporation. The aluminum is then patterned with an alignment feature pattern mask using standard photolithography techniques. As illustrated in FIG. 7, the waveguide layers 40, 42, 44 are next etched down to the substrate 26, such that the remaining waveguide material forms a pattern 30a for the alignment features 22. In the exemplary embodiment, an RIE etch of the waveguide layers may be performed according to the following conditions:
C₄F₈: 10-50 sccm
O₂: 0.5-5 sccm
RF power: 50-100 W
ICP power: 1000-2000 W
Pressure: 3-10 mTorr
   The remaining aluminum is stripped by etching. In the exemplary embodiment, a wet etch using H₄PO₃/HNO₃/glacial acetic acid is conducted to remove the aluminum. The assembly is now ready for formation of the alignment features 22 by etching of the substrate 26.

Fabrication of Alignment Features

Alignment features 22 are formed in the substrate 26 by etching, using the previously etched waveguide layers 40, 42, 44 as an alignment feature pattern 30a to define the position and size of the alignment features 22. The alignment features 22 are etched using conventional techniques. In the exemplary embodiment, the alignment features 22 are etched into the silicon wafer substrate 26 using an anisotropic etch, such as an anisotropic KOH etch. A suitable anisotropic etchant is described above with respect to the first exemplary embodiment.

Assembly

After etching of the alignment features 22, the substrate 26 is ready for additional processing to create the flat end facets of the waveguides 32, and to form individual waveguide chips having integral alignment features, as described above with respect to the first exemplary embodiment.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the mechanical, electrical, chemical and optical arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

1. A method for forming a waveguide with integral alignment features for an optical device, the method comprising:
fabricating a waveguide on a substrate;
removing a portion of the waveguide to reveal the substrate; and
forming the optical device alignment feature in the revealed substrate.

2. The method of claim 1, further comprising:
providing an alignment feature pattern on the substrate prior to fabricating a waveguide on the substrate;
wherein fabricating a waveguide on the substrate comprises fabricating a waveguide over the alignment feature pattern, and wherein removing a portion of the waveguide to reveal the substrate comprises revealing the alignment feature pattern.

3. The method of claim 2, wherein providing an alignment feature pattern on the substrate comprises:
coating the substrate with an etch stop layer;
patterning the etch stop layer with a pattern mask; and
etching the etch stop layer to form the alignment feature pattern.

4. The method of claim 3, wherein coating the substrate with an etch stop layer comprises coating the substrate with silicon nitride.

5. The method of claim 4, wherein the silicon nitride coating has a thickness in the range of 300 to 6000 Å.

6. The method of claim 3, wherein etching the etch stop layer comprises reactive ion etching.

7. The method of claim 1, wherein fabricating a waveguide comprises:
depositing a lower cladding layer over the substrate; and
depositing a waveguide core layer over the lower cladding layer.

8. The method of claim 7, wherein fabricating a waveguide further comprises:
depositing an upper cladding layer over the waveguide core layer.

9. The method of claim 7, wherein the lower cladding layer has a thickness in the range of 10 to 50 μm.

10. The method of claim 7, wherein the waveguide core layer has a thickness in the range of 0.1 to 63 μm.

11. The method of claim 8, further comprising forming discrete waveguides in the waveguide core layer prior to depositing the upper cladding layer.

12. The method of claim 7, wherein removing a portion of the waveguide to reveal the substrate comprises etching the waveguide core layer and lower cladding layer.

13. The method of claim 8, wherein removing a portion of the waveguide to reveal the substrate comprises etching the upper cladding layer, waveguide core layer and lower cladding layer.

14. The method of claim 12, wherein etching comprises using reactive ion etch (RIE).

15. The method of claim 1, wherein forming alignment features in the substrate comprises wet etching the alignment features.

16. The method of claim 15, wherein wet etching comprising using an anisotropic etch.

17. The method of claim 16, wherein the substrate is silicon and wherein using an anisotropic etch comprises using a KOH etch.

18. The method of claim 16, wherein the substrate is silicon, and wherein using an anisotropic etch comprises using an etchant based on a material selected from the group consisting essentially of ethylenediamine or tetramethyl ammonium hydroxide.

19. The method of claim 1, wherein removing a portion of the waveguide to reveal the substrate comprises forming an alignment feature pattern in the waveguide.

20. A method for passively aligning an optical fiber and an optical waveguide, the method comprising:
depositing a lower cladding layer on a substrate;
depositing a waveguide core layer on the lower cladding layer;
fabricating the optical waveguide from the waveguide core layer;
removing a portion of the waveguide core layer and lower cladding layer to reveal the substrate;
etching the revealed substrate to form an alignment groove in the substrate, the alignment groove configured to align an optical fiber with the optical waveguide; and
placing the optical fiber in the alignment groove.

21. The method of claim 20, the method further comprising:
depositing an upper cladding layer on the optical waveguide after fabricating the optical waveguide from the waveguide core layer; and
removing a portion of the upper cladding layer, waveguide core layer and lower cladding layer to reveal the substrate.

22. The method of claim 20, wherein removing a portion of the waveguide core layer and lower cladding layer to reveal the substrate comprises:
forming an alignment groove pattern in the waveguide core layer and lower cladding layer.

23. The method of claim 21, wherein removing a portion of the upper cladding layer, waveguide core layer and lower cladding layer to reveal the substrate comprises:
forming an alignment groove pattern in the upper cladding layer, waveguide core layer and lower cladding layer.

24. The method of claim 20, further comprising:
forming an alignment groove pattern on the substrate prior to depositing the lower cladding layer.

25. The method of claim 20, wherein the alignment groove is formed as a V-shaped groove.

26. A method for forming a waveguide with integral alignment features for an optical device, the method comprising:
depositing an etch stop layer on a substrate;
patterning the etch stop layer with an alignment feature pattern;
providing a waveguide over the patterned etch stop layer;
removing a portion of the waveguide to reveal the patterned etch stop layer;
etching the substrate to form alignment features in the substrate.

27. The method of claim 26, wherein depositing an etch stop layer on a substrate comprises depositing silicon nitride on a silicon wafer.

28. The method of claim 26, wherein providing a waveguide comprises:
providing a lower cladding layer over the etch stop layer;
providing a waveguide core layer over the lower cladding layer;
fabricating discrete waveguide cores in the waveguide core layer; and
depositing an upper cladding layer over the waveguide cores.

29. The method of claim 26, wherein providing a waveguide comprises:
providing a lower cladding layer over the etch stop layer;
providing a waveguide core layer over the lower cladding layer; and
fabricating discrete waveguide cores in the waveguide core layer.

30. The method of claim 26, wherein etching the substrate to form alignment features comprises using an anisotropic etch.

31. The method of claim 26, wherein removing a portion of the waveguide to reveal the etch stop layer comprises etching the waveguide.

32. A method for forming a waveguide with integral alignment features for an optical device, the method comprising:
providing a waveguide on a substrate;
patterning the waveguide with an alignment feature pattern;
removing a portion of the waveguide from the substrate to provide an alignment feature mask;
etching the substrate using the alignment feature mask to form alignment features in the substrate.
